(19) United States
(12) Patent Application Publication
(10) Pub. No.: US 2009/0249197 A1
(43) Pub. Date: Oct. 1, 2009

(54) DOCUMENT PROOFREADING SUPPORT METHOD AND DOCUMENT PROOFREADING SUPPORT APPARATUS

(75) Inventors: Tomoki Nagase, Kawasaki (JP); Masaru Fuji, Kawasaki (JP); Seiji Okura, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/414,606

(22) Filed: Mar. 30, 2009

(30) Foreign Application Priority Data
Mar. 31, 2008 (JP) 2008-092974

(51) Int. Cl. G06F 17/21

(52) U.S. Cl. 715/260; 715/259

(57) ABSTRACT

An apparatus includes a mechanism for selecting a replacement source expression associated with respective replacement destination expressions, and the respective replacement destination expressions associated with the replacement source expression; a mechanism for extracting the replacement source expression associated with the replacement destination expression which is the same expression as the selected replacement destination expression, and creating an expression list; a mechanism for determining whether or not an expression group included in the expression list for one field is similar to an expression group included in the expression list; and a mechanism for generating a proofreading complementary dictionary, which associates an expression included in the expression list with a high replacement destination expression included in the expression list.

### CROSS-REFERENCE TO RELATED APPLICATIONS

This application is related to and claims priority to Japanese patent application no. 2008-92974 filed on Mar. 31, 2008 in the Japan Patent Office, and incorporated by reference herein.

### FIELD

The present invention relates to a document proofreading support method and a document proofreading support apparatus for supporting proofreading in which a term in a document created for each of a plurality of fields is replaced.

### BACKGROUND

Conventionally, as a proofreading support technique for supporting standardization of terms in a document creation operation, there has been known a technique for using a proofreading dictionary in which a replacement source expression and a replacement destination expression are associated with each other. In the proofreading support technique for using a proofreading dictionary, upon detection of a replacement source expression in an original text, the replacement source expression is replaced with a replacement destination expression and/or an alert is provided to a user based on the proofreading dictionary.

However, in the case of creating a massive document, a document creation operation is generally performed for each project and/or for each field. If the above-described proofreading support technique is applied to the operation of creating such a massive document, the above-mentioned proofreading dictionary is created for each project and/or for each field. In such a technique, entries registered in the proofreading dictionary (e.g., information by which a replacement source expression and a replacement destination expression are associated with each other) can be prepared in advance to some extent.

However, it is hard to grasp entries that should truly be registered in the proofreading dictionary until a disagreement actually occurs between terms in a term standardization operation. Therefore, it has been not easy to create a proofreading dictionary that covers a wide range of terms for a field in which a document is poorly created, e.g., a field for which replacement of terms for term standardization is poorly performed.

### SUMMARY

According to an aspect of the invention, a document proofreading support apparatus supports proofreading in which a term in a document created for each of a plurality of fields is replaced. The document proofreading support apparatus includes an expression selection mechanism for selecting, from a proofreading dictionary that stores a replacement source expression and a replacement destination expression in association with each other for each field, a replacement source expression associated with respective replacement destination expressions for a plurality of fields, and the respective replacement destination expressions for a plurality of fields associated with the replacement source expression; a list creation mechanism for extracting, for each of the replacement destination expressions for a plurality of fields selected by the expression selection mechanism, the replacement source expression associated with the replacement destination expression which is the same expression as the selected replacement destination expression from the proofreading dictionary, and creating an expression list including the extracted replacement source expression and the replacement destination expression associated with the extracted replacement source expression; a similarity determination mechanism for determining, among the expression lists for a plurality of fields created by the list creation mechanism, whether or not an expression group included in the expression list for one field is similar to an expression group included in the expression list for the other field; a complementary dictionary generation mechanism for generating, when there exists the expression list for the other field determined as being similar by the similarity determination mechanism, a proofreading complementary dictionary for the one field, which associates an expression included in the expression list for the other field with a high replacement destination expression included in the expression list for the one field; and a proofreading support mechanism for supporting proofreading of a document that is an object to be proofread by using the proofreading complementary dictionary generated by the complementary dictionary generation mechanism and the proofreading dictionary.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF DRAWINGS

FIG. 1 is a functional block diagram illustrating a configuration of a document proofreading support apparatus according to the present embodiment.

FIG. 2 is a diagram for describing a concept of a proofreading dictionary.

FIG. 3 is a diagram illustrating examples of entries registered in the proofreading dictionary.

FIG. 4 is a diagram for describing a concept of a proofreading complementary dictionary.

FIG. 5 is a diagram illustrating examples of entries registered in the proofreading complementary dictionary.

FIG. 6 is a diagram illustrating an example of an entry registered in a replacement invalidation table.

FIG. 7 is a diagram illustrating examples of expression lists created by a list creation section.

FIG. 8A is a flow chart (1) illustrating the flow of proofreading complementary dictionary generation performed by the document proofreading support apparatus according to the present embodiment.

FIG. 8B is a flow chart (2) illustrating the flow of the proofreading complementary dictionary generation performed by the document proofreading support apparatus according to the present embodiment.

FIG. 9 is a functional block diagram illustrating a configuration of a computer for executing a document proofreading support program according to the present embodiment.

### DESCRIPTION OF EMBODIMENT

Hereinafter, an embodiment of the present invention will be described in detail with reference to the appended drawings.

First, the general outlines of a document proofreading support apparatus according to the present embodiment will be described. Based on a proofreading dictionary, the document proofreading support apparatus according to the present embodiment detects, from among terms in an inputted document, a candidate for an expression that should be replaced, and outputs, as a proofreading result, the detected candidate together with information of an expression serving as a replacement destination. As used herein, the “proofreading dictionary” refers to definition information by which a replacement source expression and a replacement destination expression are associated with each other for each field.

Further, the document proofreading support apparatus according to the present embodiment also has the function of automatically generating a proofreading complementary dictionary serving as a proofreading dictionary for complementing a proofreading dictionary for replacing expressions concerning term standardization. For example, the document proofreading support apparatus generates the proofreading complementary dictionary by utilizing defined proofreading dictionary entries to replace same or similar expressions with different expressions from a plurality of related or similar fields.

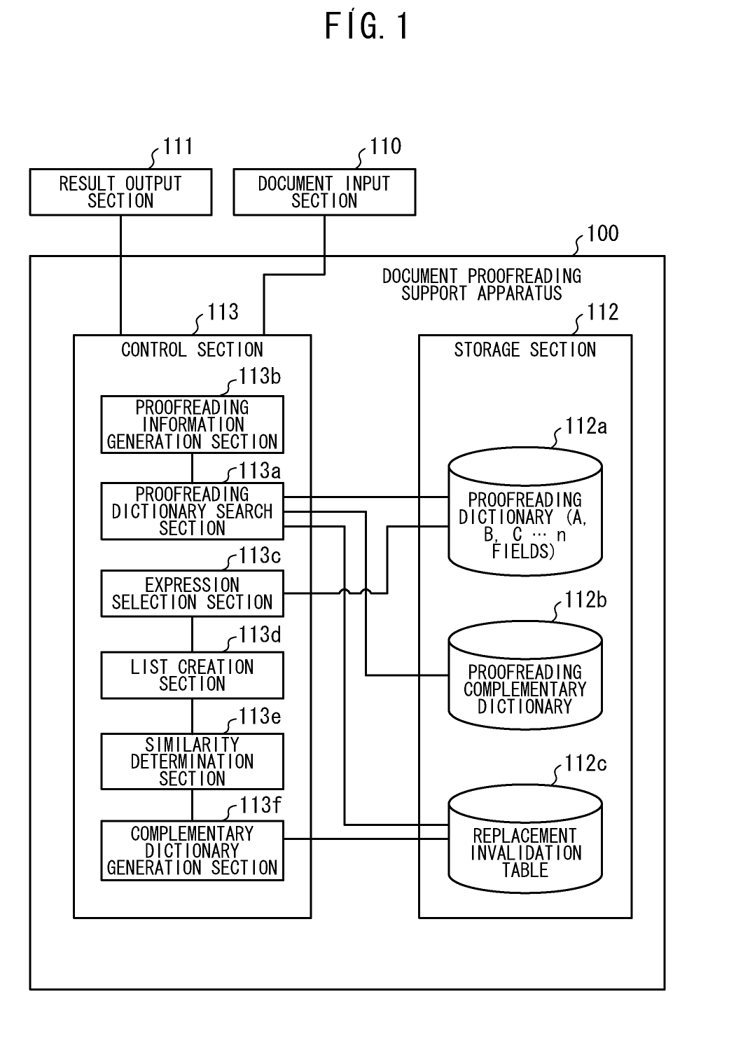

Hereinafter, the document proofreading support apparatus according to the present embodiment will be described in detail. First, a configuration of the document proofreading support apparatus according to the present embodiment will be described. FIG. 1 is a functional block diagram illustrating the configuration of the document proofreading support apparatus according to the present embodiment. As shown in this diagram, the document proofreading support apparatus 100 has a document input section 110; a result output section 111; a storage section 112; and a control section 113.

The document input section 110 serves as an input section for reading a document that is an object to be proofread. The document input section 110 may read documents one after another, or may collectively read a plurality of documents.

The result output section 111 serves as an output section for outputting proofreading information generated by a proofreading information generation section 113b (described below). Each time the result output section 111 receives proofreading information from the proofreading information generation section 113b, the result output section 111 allows a display section (not shown) to display the proofreading information. Alternatively, the proofreading information generation section 113b may create a report in which a plurality of pieces of proofreading information are collected, and then may output the created report as another document or may output the created report by inserting the created report into an original text object document as a note.

The storage section 112 serves as a storage section for storing data and programs necessary for various processes performed by the control section 113. In the present embodiment, the storage section 112 stores a proofreading dictionary 112a, a proofreading complementary dictionary 112b, and a replacement invalidation table 112c.

The proofreading dictionary 112a serves as a table that defines replacement of expressions for standardizing terms at the time of document creation. For example, the proofreading dictionary 112a stores a replacement source expression and a replacement destination expression in association with each other for each field.

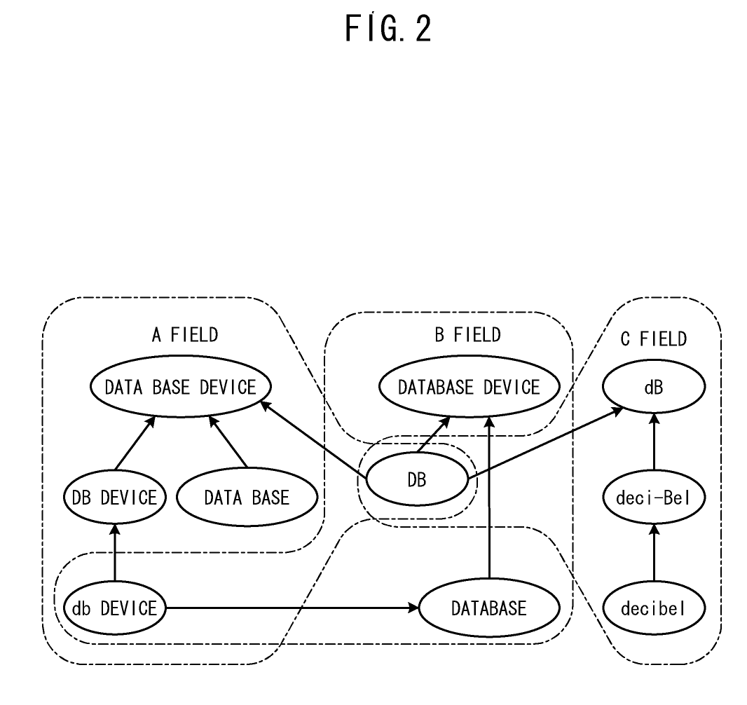

FIG. 2 is a diagram describing a concept of the proofreading dictionary 112a. In this diagram, characters surrounded by ellipses each represent a replacement source expression or a replacement destination expression. Further, in this diagram, each arrow between the ellipses indicates the association between the replacement source expression and replacement destination expression, and the direction of each arrow indicates the direction from the replacement source expression to the replacement destination expression.

As shown in the diagram, for example, the proofreading dictionary 112a stores the replacement source expressions and the replacement destination expressions in association with each other for each of the following three fields: A, B, and C fields. Furthermore, in the example shown in this diagram, the proofreading dictionary 112a stores “data base device”, “DB device”, “data base”, “DB”, and “db device” as expressions for the A field. In the A field, “data base device” is stored as a replacement destination expression for “DB device”, “data base”, and “DB”, while “DB device” is stored as a replacement destination expression for “db device”.

Moreover, the proofreading dictionary 112a stores “database device”, “DB”, “db device”, and “database” as expressions for the B field. In the B field, “database device” is stored as a replacement destination expression for “DB” and “database”. In addition, the proofreading dictionary 112a stores “dB”, “deci-Bel”, “DB”, and “decibel” as expressions for the C field. In the C field, “dB” is stored as a replacement destination expression for “deci-Bel” and “DB”, while “deci-Bel” is stored as a replacement destination expression for “decibel”.

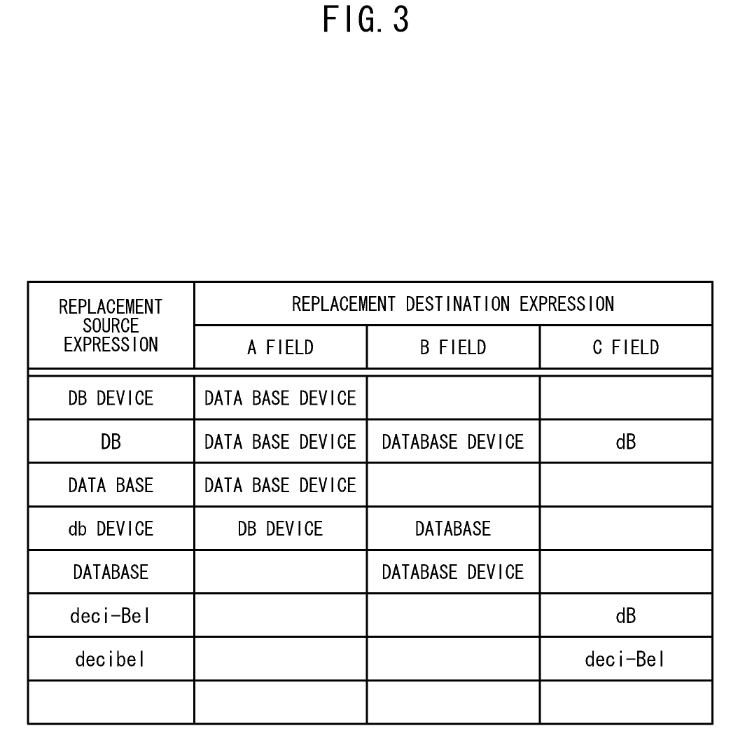

FIG. 3 is a diagram illustrating examples of entries registered in the proofreading dictionary 112a. This diagram shows a case where the replacement source expressions and replacement destination expressions shown in FIG. 2 are registered as entries in the proofreading dictionary 112a. As shown in this diagram, for example, the proofreading dictionary 112a stores, for each replacement source expression, entries each associating the replacement source expression with the replacement destination expressions for the A, B, and C fields. Although this example shows the case where the entries for the A, B, and C fields are stored in a single table, the respective entries may be stored in different tables for the respective fields.

The proofreading complementary dictionary 112b serves as a table for complementing the proofreading dictionary 112a in replacing expressions concerning term standardization. For example, similarly to the proofreading dictionary 112a, the proofreading complementary dictionary 112b stores replacement source expressions and replacement destination expressions in association with each other for each field.

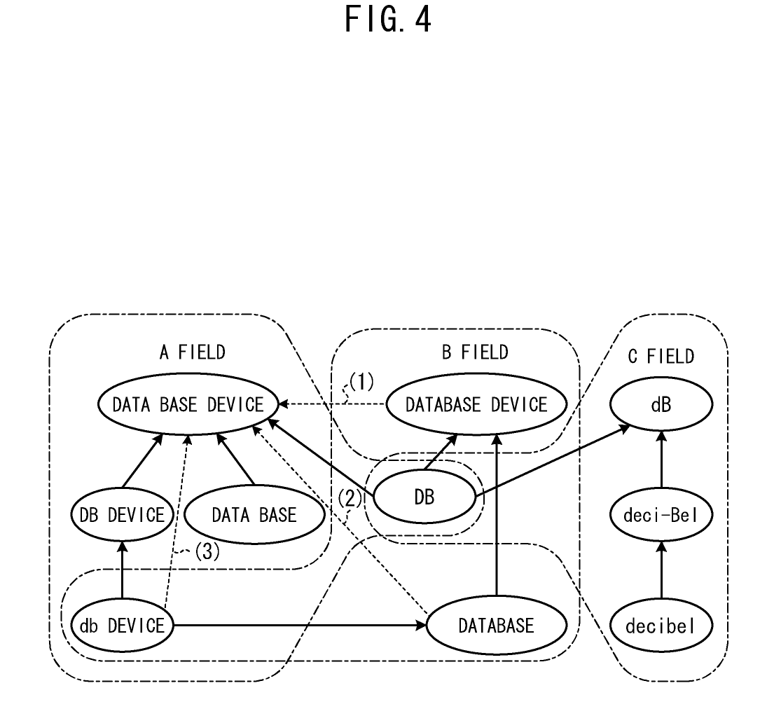

FIG. 4 is a diagram for describing a concept of the proofreading complementary dictionary 112b. As shown in this diagram, for example, the proofreading complementary dictionary 112b stores “data base device” for the A field as a replacement destination for “database device” for the B field (see FIG. 4(1)). Further, the proofreading complementary dictionary 112b stores “data base device” for the A field as a replacement destination for “database” for the B field (see FIG. 4(2)). Furthermore, the proofreading complementary dictionary 112b stores “data base device” for the A field as a replacement destination for “db device” for the same field, e.g., for the A field (see FIG. 4(3)).

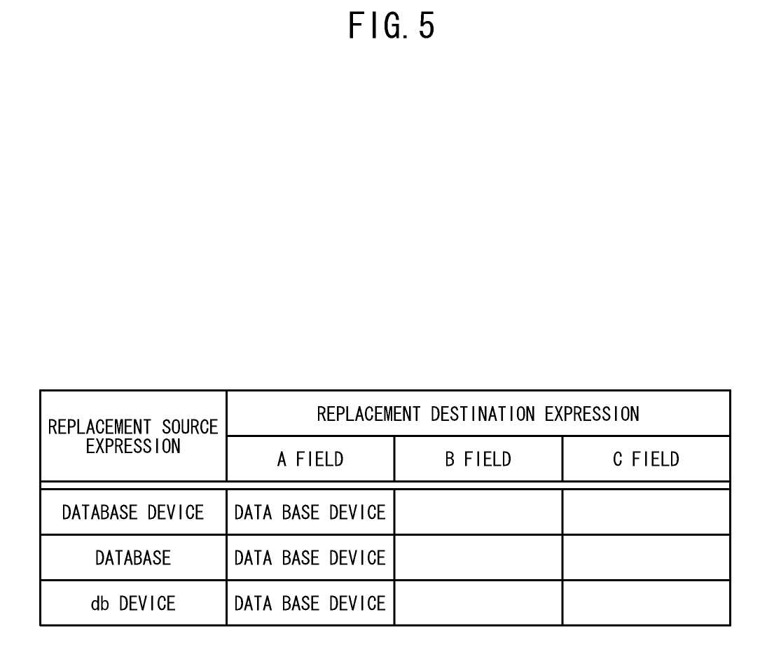

FIG. 5 is a diagram illustrating examples of entries registered in the proofreading complementary dictionary 112b. This diagram shows a case where the replacement source expressions and replacement destination expressions shown in FIGS. 4(1), (2), and (3) are registered as entries in the proofreading complementary dictionary 112b. As shown in this diagram, for example, the proofreading complementary dictionary 112b stores, for each replacement source expression, entries each associating the replacement source expression with the replacement destination expressions for the A, B, and C fields.

In the example shown in this diagram, the proofreading complementary dictionary 112b stores, as an entry representing FIG. 4(1), an entry that associates “database device”, which is a replacement source expression, with “data base device” serving as a replacement destination for the A field. Furthermore, the proofreading complementary dictionary 112b stores, as an entry representing FIG. 4(2), an entry that associates “database”, which is a replacement source expression, with “data base device” serving as a replacement destination for the A field. Furthermore, the proofreading complementary dictionary 112b stores, as an entry representing FIG. 4(3), an entry that associates “db device”, which is a replacement source expression, with “data base device” serving as a replacement destination for the A field.

Although this embodiment shows the case where only the replacement destination expressions for the A field are associated with the replacement source expressions, the replacement destination expressions for the B field and/or C field may also be associated with the replacement source expressions.

The replacement invalidation table 112c serves as a table for invalidating expression replacement performed based on the proofreading dictionary 112a. For example, similarly to the proofreading dictionary 112a, the replacement invalidation table 112c stores a replacement source expression and a replacement destination expression in association with each other for each field.

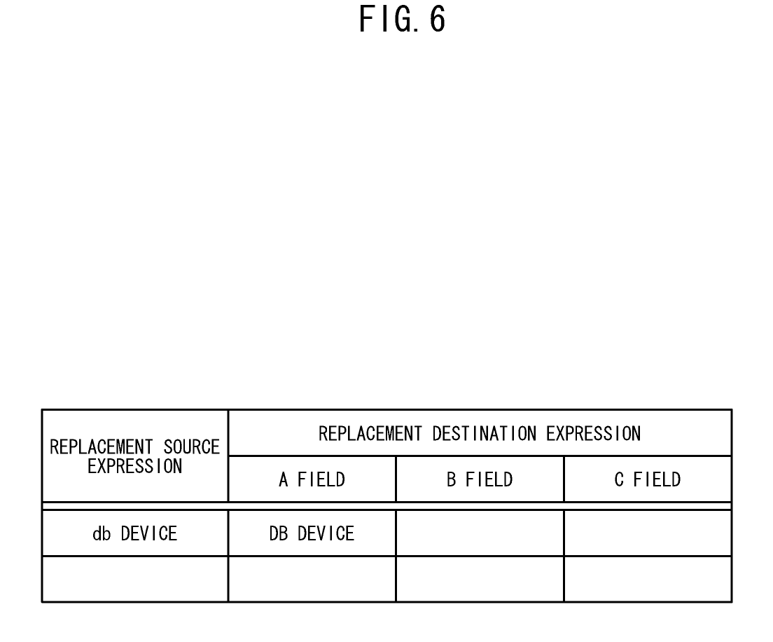

FIG. 6 is a diagram illustrating an example of an entry registered in the replacement invalidation table 112c.

As shown in this diagram, for example, the replacement invalidation table 112c stores, in association with each other, “db device” which is a replacement source expression, and “DB device” defined as a replacement destination for the A field. The entry shown in this diagram invalidates the replacement of “db device” with “DB device” for the A field, which is performed based on the proofreading dictionary 112a shown in FIG. 2.

Although this embodiment shows the case where only the replacement destination expression for the A field is associated with the replacement source expression, the replacement destination expressions for the B field and/or C field may also be associated with the replacement source expression.

The control section 113 serves as a processing section that has an internal memory for storing a control program for an OS (Operating System) or the like, a program that specifies various process procedures or the like, and necessary data, and executes various processes with these programs and data. For example, the control section 113 includes a proofreading dictionary search section 113a, a proofreading information generation section 113b, an expression selection section 113c, a list creation section 113d, a similarity determination section 113e, and a complementary dictionary generation section 113f.

The proofreading dictionary search section 113a serves as a process section for searching the proofreading dictionary 112a and the proofreading complementary dictionary 112b by using, as a key, a character string included in a document that is an object to be proofread. For example, the proofreading dictionary search section 113a searches the proofreading dictionary 112a and the proofreading complementary dictionary 112b by using, as a key, a character string included in a document that is read by the document input section 110 and is an object to be proofread, thereby detecting a candidate for a term that should be replaced (e.g., a term that matches a replacement source expression).

Then, the proofreading dictionary search section 113a passes the detected term candidate (hereinafter, called a “replacement candidate”) to the proofreading information generation section 113b (described below). At this time, the proofreading dictionary search section 113a confirms whether or not a replacement source expression that matches the detected replacement candidate is stored in the replacement invalidation table 112c. When the matching replacement source expression is stored in the replacement invalidation table 112c, the proofreading dictionary search section 113a excludes the replacement candidate stored in the replacement invalidation table 112c from objects to be passed to the proofreading information generation section 113b.

As a character search method performed by the proofreading dictionary search section 113a for example, “perfect matching” for searching for an entry identical to a search key may be used, or “partial search” for searching for an entry that matches a portion of a few characters from a search key may be used. Then, in order to increase the speed of the character search performed by the proofreading dictionary search section 113a, an index is preferably generated if the scale of the proofreading dictionary 112a is large.

The proofreading information generation section 113b serves as a process section for generating proofreading information for supporting the proofreading of a document that is an object to be proofread. For example, upon detection of a replacement candidate by the proofreading dictionary search section 113a, the proofreading information generation section 113b generates proofreading information including the detected replacement candidate, and the replacement destination expression associated with this replacement candidate in the proofreading dictionary 112a and in the proofreading complementary dictionary 112b. Then, the proofreading information generation section 113b passes the generated proofreading information to the result output section 111.

The expression selection section 113c serves as a process section for selecting, from the proofreading dictionary 112a, a replacement source expression associated with respective replacement destination expressions for a plurality of fields, and the respective replacement destination expressions for a plurality of fields, which are associated with the replacement source expression.

For example, first, the expression selection section 113c determines the field of an original text for which the proofreading complementary dictionary 112b is created. In this embodiment, for example, the expression selection section 113c may determine, as the field of an original text, a field specified by a user through a dialog, or may determine, as the field of an original text, a field specified by a parameter from the outside. Hereinafter, the description will be made based on the case where the field of an original text is the A field.

For example, when the field of an original text is the A field, the expression selection section 113c searches for an entry in which a replacement destination expression for the A field is set, and in which a replacement destination expression for a field other than the A field is also set, while sequentially reading the entries stored in the proofreading dictionary 112a from the first entry. Then, when the appropriate entry exists, the expression selection section 113c selects a replacement source expression for this entry, and respective replacement destination expressions for a plurality of fields (the A field and the other field), which are associated with this replacement source expression.

For example, in the example of the proofreading dictionary 112a shown in FIG. 3, the expression selection section 113c selects, from the second entry, “DB” as a replacement source expression, and selects “data base device” for the A field, “database device” for the B field, and “dB” for the C field as replacement destination expressions. Alternatively, the expression selection section 113c selects, from the fourth entry, “db device” as a replacement source expression, and selects “DB device” for the A field and “database” for the B field as replacement destination expressions.

The list creation section 113d serves as a process section for creating an expression list for each field based on the replacement destination expressions for a plurality of fields selected by the expression selection section 113c. For example, for each of the replacement destination expressions for a plurality of fields selected by the expression selection section 113c, the list creation section 113d extracts, from the proofreading dictionary 112a, a replacement source expression associated with a replacement destination expression which is the same expression as the selected replacement destination expression. Then, the list creation section 113d creates an expression list including the extracted replacement source expression, and the replacement destination expression associated with the extracted replacement source expression.

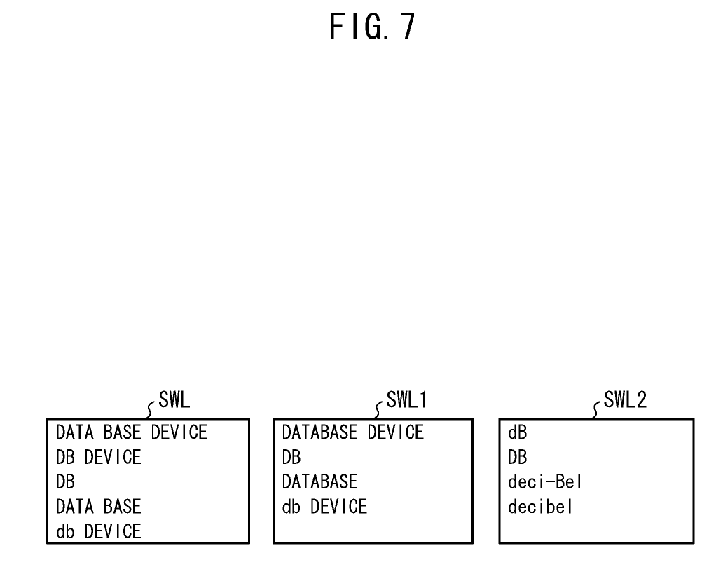

FIG. 7 is a diagram illustrating examples of expression lists created by the list creation section 113d. This diagram illustrates the expression lists created based on the replacement source expressions and replacement destination expressions selected from the proofreading dictionary 112a in FIG. 3 in the case where the field of an original text is the A field.

As illustrated in this diagram, first, the list creation section 113d extracts the replacement source expressions “DB device”, “DB”, and “data base” associated with the same expression as “data base device” for the A field among a plurality of replacement destination expressions selected by the expression selection section 113c. Then, the list creation section 113d creates an expression list SWL including “DB device”, “DB”, and “data base,” which are the extracted replacement source expressions, and “data base device” which is the replacement destination expression associated with the replacement source expressions.

Subsequently, the list creation section 113d extracts the replacement source expressions “DB” and “database” associated with the same expression as “database device” for the B field among a plurality of replacement destination expressions selected by the expression selection section 113c. Then, the list creation section 113d creates an expression list SWL1 including “DB” and “database”, which are the extracted replacement source expressions, and “database device”, which is the replacement destination expression associated with these replacement source expressions.

Subsequently, the list creation section 113d extracts the replacement source expressions “DB” and “deci-Bel” associated with the same expression as “dB” for the C field among a plurality of replacement destination expressions selected by the expression selection section 113c. Then, the list creation section 113d creates an expression list SWL2 including “DB” and “deci-Bel”, which are the extracted replacement source expressions, and “dB” which is the replacement destination expression associated with these replacement source expressions.

Moreover, the list creation section 113d extracts, from the proofreading dictionary 112a, a replacement source expression associated with a replacement destination expression which is the same expression as a replacement source expression included in the created expression list, and recursively repeats a process of adding the extracted replacement source expression to the expression list.

For example, in the example of the proofreading dictionary 112a shown in FIG. 3, the list creation section 113d extracts, from the proofreading dictionary 112a, “db device” for which “DB device” included in the list SWL is determined as a replacement destination expression, and adds “db device” to the list SWL. Further, the list creation section 113d extracts, from the proofreading dictionary 112a, “db device” for which “database” included in the list SWL1 is determined as a replacement destination expression, and adds “db device” to the list SWL1. Furthermore, the list creation section 113d extracts, from the proofreading dictionary 112a, “decibel” for which “deci-Bel” included in the list SWL2 is determined as a replacement destination expression, and adds “decibel” to the list SWL2.

The similarity determination section 113e serves as a process section for determining, among the expression lists for a plurality of fields created by the list creation section 113d, whether or not an expression group included in the expression list for one field is similar to an expression group included in the expression list for the other field.

In this embodiment, the determination of similarity among the expression groups by the similarity determination section 113e is performed using a known similarity evaluation technique. Typical methods of the similarity evaluation technique include a method for using co-occurrence frequency in a corpus and/or a thesaurus. Methods of calculating similarity between words utilizing a dictionary (thesaurus) include a method described in “Word Similarity Computed on an English Dictionary (the 46th Annual Convention of Information Processing Society of Japan (2B-2))”.

Further, in the method of using co-occurrence frequency in a corpus, for example, the frequency of co-occurrence of words in the list SWL and words in the list SWL1 within the range of ten words is calculated for combinations of all elements, an “n” number of combinations are obtained from the combinations with high co-occurrence frequency, and the total value thereof is determined as the similarity among the word groups.

For example, in the method of using co-occurrence frequency in a corpus, word similarity is calculated based on the number of documents in which a word “A” appears, the number of documents in which a word “B” appears and the number of documents in which the word “A” and word “B” appear together in a collection of sufficiently large texts (such as texts on the Web, for example). That is, if the number of documents in which the word “A” appears is “freq (A)”, the number of documents in which the word “B” appears is “freq (B)”, and the number of documents in which the word “A” and word “B” appear together is “freq (A and B)”, word similarity “sim (A, B)” may be expressed in the following equation:

sim(A,B)=(freq(A and B)/freq(A)+freq(A and B)/freq(B))/2

Instead of the number of documents in which the word “A” appears, the number of documents in which the word “B” appears and the number of documents in which the word “A” and word “B” appear together, the frequency of appearance of the word “A”, the frequency of appearance of the word “B” and the frequency of the appearance together of the word “A” and word “B” may be used in calculating the word similarity.

Furthermore, the determination of similarity between a word group “X” and a word group “Y” may be performed, for example, by the following steps (1) to (3).

(1) Word similarity is calculated for all combinations of respective words in the word group “X” and respective words in the word group “Y”, and the word groups “X” and “Y” are determined to be similar to each other when the total sum of the calculated word similarities is equal to or greater than a threshold value L1. On the other hand, the word groups “X” and “Y” are determined to be not similar to each other when the total sum is less than the threshold value L1.

(2) Word similarity is calculated for all combinations of respective words in the word group “X” and respective words in the word group “Y”, and the word groups “X” and “Y” are determined to be similar to each other when the total of the top “n” number of word similarities among the calculated word similarities is equal to or greater than a threshold value L2. On the other hand, the word groups “X” and “Y” are determined to be not similar to each other when the total of the top “n” number of word similarities among the calculated word similarities is less than the threshold value L2.

(3) Word similarity is calculated for all combinations of respective words in the word group “X” and respective words in the word group “Y”, and the word groups “X” and “Y” are determined to be similar to each other when the total of the calculated word similarities, which are equal to or greater than a threshold value L4, is equal to or greater than a threshold value L5. On the other hand, the word groups “X” and “Y” are determined to be not similar to each other when the total of the calculated word similarities, which are equal to or greater than the threshold value L4, is less than the threshold value L5.

Using the above-described methods, for example, when the field of an original text is the A field, the similarity determination section 113e determines whether or not the expression group of the list SWL and the expression group in the list SWL1 shown in FIG. 7 are similar to each other, and further determines whether or not the expression group in the list SWL and the expression group in the list SWL2 are similar to each other.

The complementary dictionary generation section 113f serves as a process section for generating a proofreading complementary dictionary when there exists an expression list for the other field determined as being similar by the similarity determination section 113e. For example, the complementary dictionary generation section 113f generates, when there exists an expression list for the other field determined as being similar, a proofreading complementary dictionary for one field, which associates an expression in the expression list for the other field with a high or the highest replacement destination expression in the expression list for one field.

For example, for the expression lists shown in FIG. 7, when the list SWL and the list SWL1 are determined to be similar to each other, the complementary dictionary generation section 113f associates the expression “database device” in the list SWL1 with a high or the highest replacement destination expression “data base device” in the list SWL. Furthermore, the complementary dictionary generation section 113f associates the expression “DB” in the list SWL1 with a high or the highest replacement destination expression “data base device” in the list SWL. Furthermore, the complementary dictionary generation section 113f associates the expression “database” in the list SWL1 with a high or the highest replacement destination expression “data base device” in the list SWL. Moreover, the complementary dictionary generation section 113f associates the expression “db device” in the list SWL1 with a high or the highest replacement destination expression “data base device” in the list SWL.

Then, the complementary dictionary generation section 113f registers, as an entry for the A field, the associated replacement source expression and replacement destination expression in the proofreading complementary dictionary 112b. At this time, the complementary dictionary generation section 113f confirms whether or not an entry, which is the same as the associated replacement source expression and replacement destination expression, is registered in the proofreading dictionary 112a. Then, if the same entry is registered in the proofreading dictionary 112a, the complementary dictionary generation section 113f excludes the replacement source expression and replacement destination expression from objects to be registered in the proofreading complementary dictionary 112b (in this embodiment, the entry associating “DB” with “data base device” is excluded). As a result, the proofreading complementary dictionary 112b will be in the state shown in FIG. 5.

When there exists an overlapping entry among the entries of the proofreading complementary dictionary 112b and the entries of the proofreading dictionary 112a, the complementary dictionary generation section 113f registers this overlapping entry in the replacement invalidation table 112c.

For example, in the example of the proofreading dictionary 112a shown in FIG. 3 and the proofreading complementary dictionary 112b shown in FIG. 5, there exists an overlapping entry in which the replacement source expression is “db device” and the replacement destination for the A field is “DB device”. Therefore, the complementary dictionary generation section 113f registers the entry in which the replacement source expression is “db device” and the replacement destination for the A field is “DB device” in the replacement invalidation table 112c. As a result, the replacement invalidation table 112c will be in the state shown in FIG. 6.

Although the description has been made based on the case where expression replacement is performed for the three fields A, B, and C for the sake of convenience of the description, the number of fields subjected to proofreading support is not limited to three, but may be three or more, or less than three.

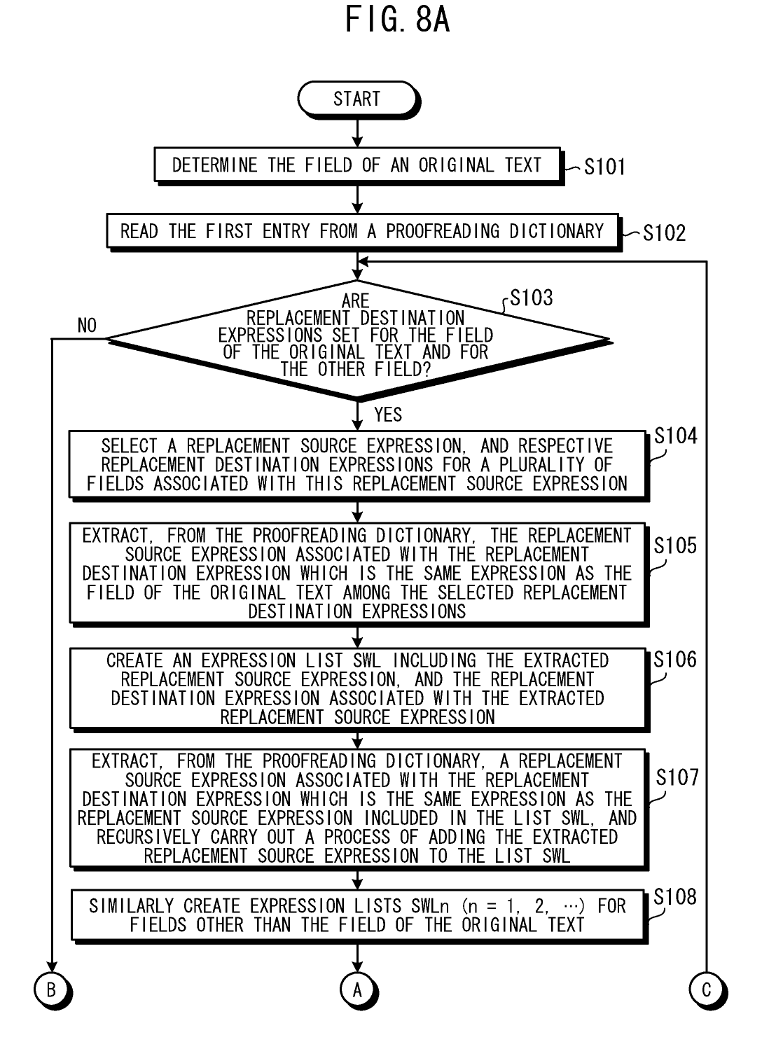

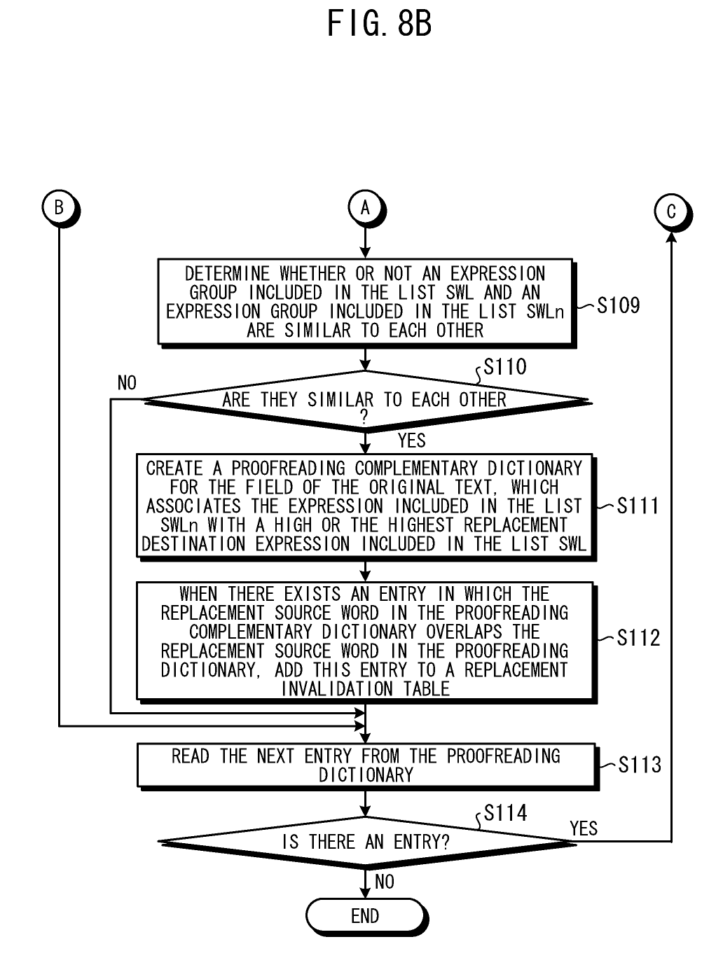

Next, the flow of proofreading complementary dictionary generation performed by the document proofreading support apparatus according to the present embodiment will be described. FIGS. 8A and 8B are flow charts (1) and (2) each illustrating the flow of the proofreading complementary dictionary generation performed by the document proofreading support apparatus according to the present embodiment. As shown in FIG. 8A, in the document proofreading support apparatus according to the present embodiment, first, the expression selection section 113c determines the field of an original text (Step S101), and reads the first entry from the proofreading dictionary 112a (Step S102).

In this step, when no replacement destination expression for the field of the original text is set in the read entry, or when a replacement destination expression for the field of the original text is set but a replacement destination expression for the other field is not set in the read entry (e.g., when the answer is No in Step S103), the expression selection section 113c reads the next entry from the proofreading dictionary 112a (Step S113).

On the other hand, when a replacement destination expression for the field of the original text is set and a replacement destination expression for the other field is also set in the read entry (e.g., when the answer is Yes in Step S103), the expression selection section 113c selects a replacement source expression of this entry, and respective replacement destination expressions for a plurality of fields which are associated with this replacement source expression (Step S104).

Subsequently, the list creation section 113d extracts, from the proofreading dictionary 112a, a replacement source expression associated with the replacement destination expression which is the same expression as the field of the original text among the replacement destination expressions selected by the expression selection section 113c (Step S105). Then, the list creation section 113d creates the expression list SWL including the extracted replacement source expression, and the replacement destination expression associated with the extracted replacement source expression (Step S106).

Subsequently, the list creation section 113d extracts, from the proofreading dictionary, a replacement source expression associated with the replacement destination expression which is the same expression as the replacement source expression included in the list SWL, and recursively carries out a process of adding the extracted replacement source expression to the list SWL (Step S107). Then, the list creation section 113d similarly creates expression lists SWLn (n=1, 2, . . . ) for fields other than the field of the original text among the replacement destination expressions selected by the expression selection section 113c (Step S108).

Subsequently, as shown in FIG. 8B, the similarity determination section 113e determines whether or not an expression group included in the list SWL and an expression group included in the list SWLn are similar to each other (Step S109). In this step, when the expression group included in the list SWL and the expression group included in the list SWLn are not similar to each other (e.g., when the answer is No in Step S110), the expression selection section 113c reads the next entry from the proofreading dictionary 112a (Step S113).

On the other hand, when the expression group included in the list SWL and the expression group included in the list SWLn are similar to each other (e.g., when the answer is Yes in Step S110), the complementary dictionary generation section 113f creates a proofreading complementary dictionary for the field of the original text, which associates the expression included in the list SWLn with a high or the highest replacement destination expression included in the list SWL (Step S111).

Furthermore, when there exists an entry in which the replacement source word in the proofreading complementary dictionary 112b overlaps the replacement source word in the proofreading dictionary, the complementary dictionary generation section 113f adds this entry to the replacement invalidation table 112c (Step S112).

Subsequently, the expression selection section 113c reads the next entry from the proofreading dictionary 112a (Step S113), and when the entry can be read (e.g., when the answer is Yes in Step S114), the process goes back to Step S103 to confirm whether or not replacement destination expressions for the field of the original text and the other field are set in the read entry.

Thus, the process steps of Step S103 to S114 are repeated while entries exist in the proofreading dictionary 112a, and when all the entries have been read from the proofreading dictionary 112a (e.g., when the answer is No in Step S114), the series of process steps are ended.

As described above, in the present embodiment, the proofreading dictionary 112a stores a replacement source expression and a replacement destination expression in association with each other for each field. Then, the expression selection section 113c selects, from the proofreading dictionary 112a, a replacement source expression associated with respective replacement destination expressions for a plurality of fields, and the respective replacement destination expressions for a plurality of fields associated with the replacement source expression. Subsequently, for each of the replacement destination expressions for a plurality of fields selected by the expression selection section 113c, the list creation section 113d extracts, from the proofreading dictionary 112a, the replacement source expression associated with the replacement destination expression which is the same expression as the selected replacement destination expression, thereby creating an expression list including the extracted replacement source expression, and the replacement destination expression associated with the extracted replacement source expression. Subsequently, the similarity determination section 113e determines, from among the expression lists for a plurality of fields created by the list creation section 113d, whether or not an expression group included in the expression list for one field is similar to an expression group included in the expression list for the other field. Subsequently, when there exists an expression list for the other field determined as being similar by the similarity determination section 113e, the complementary dictionary generation section 113f generates the proofreading complementary dictionary 112b for one field, which associates an expression included in the expression list for the other field with a high or the highest replacement destination expression included in the expression list for one field. Then, the proofreading dictionary search section 113a and the proofreading information generation section 113b use the proofreading complementary dictionary 112b generated by the complementary dictionary generation section 113f and the proofreading dictionary 112a, to support the proofreading of a document that is an object to be proofread. Accordingly, the present embodiment utilizes entries in a proofreading dictionary that defines replacement of the same expression with individual expressions for a plurality of adjacent fields to perform registration in the proofreading complementary dictionary 112b, thus making it possible to easily create a proofreading dictionary that covers a wide range of terms.

Furthermore, in the present embodiment, after having created an expression list, the list creation section 113d extracts, from the proofreading dictionary 112a, a replacement source expression associated with the replacement destination expression which is the same expression as the replacement source expression included in this expression list, and recursively repeats a process of adding the extracted replacement source expression to the expression list. Accordingly, in the present embodiment, the proofreading complementary dictionary 112b can be further increased, thus making it possible to create a proofreading dictionary that covers a wider range of terms.

Moreover, in the present embodiment, after the complementary dictionary generation section 113f has created a proofreading complementary dictionary for one field, if there exists an overlapping replacement source expression among the replacement source expressions included in the proofreading complementary dictionary and the replacement source expressions included in the proofreading dictionary 112a, the complementary dictionary generation section 113f registers the overlapping replacement source expression in the replacement invalidation table 112c. Then, as for proofreading in which a term of the replacement source expression registered in the replacement invalidation table 112c is replaced, the proofreading dictionary search section 113a and the proofreading information generation section 113b support the proofreading of a document that is an object to be proofread by using only the proofreading complementary dictionary 112b. Accordingly, in the present embodiment, proofreading without performing unnecessary replacement in replacing a term may be efficiently supported.

There has conventionally been a problem that there exists no technique for supporting standardization of terms across projects or fields in the course of hierarchical document integration in writing a massive document. In an actual method of creating a massive document, the following hierarchical integration procedure is often taken. First, each person writes his or her part, documents are integrated in a small project, and then all the documents are integrated. However, in the case of a proofreading dictionary in a small project, sharing the proofreading dictionary even in adjacent fields is difficult. This is because even in the same field such as the field of medicine, a term representing the same meaning might be different between clinical trial and pathology for example, and therefore, the proofreading dictionary may not be used in common.

However, in the present embodiment, a proofreading dictionary is created for each field in advance, and at the step of performing document integration, a user specifies the name of the field that becomes a central field after the integration, thereby organically connecting the contents of the respective proofreading dictionaries for adjacent fields. Accordingly, in the present embodiment, standardization of terms for fields specified by a user can be automatically performed.

Furthermore, there has conventionally been a problem that a disagreement occurs among terms due to the passage of time. For example, in creating an application document for a new drug, it may take ten years or more in order to organize clinical trial results after the start of basic research. However, a word serving as a destination for standardization might be changed in a document written for ten years or more earlier. In other words, it may be difficult to apply a proofreading dictionary of the past due to the passage of time. In such a case, the proofreading dictionary has conventionally been updated manually. However, in the present embodiment, even if a disagreement has occurred among terms due to the passage of time, a complementary proofreading dictionary can be automatically generated with the latest definition, thus avoiding conventional manual updating.

Besides, there has conventionally been a problem that when fields are minutely divided, collecting previous examples of replacement of terms for registration of entries in a proofreading dictionary is difficult. However, the present embodiment provides a framework for mutual utilization of term replacement for adjacent fields, thus making it possible to expect substantially the same effects as in the case where the term replacement for adjacent fields has occurred in the respective fields.

Furthermore, although the present embodiment has been described based on the document proofreading support apparatus, a document proofreading support program having the similar functions can be achieved by implementing the configuration of the document proofreading support apparatus by software. Therefore, a computer for executing such a document proofreading support program will be described below.

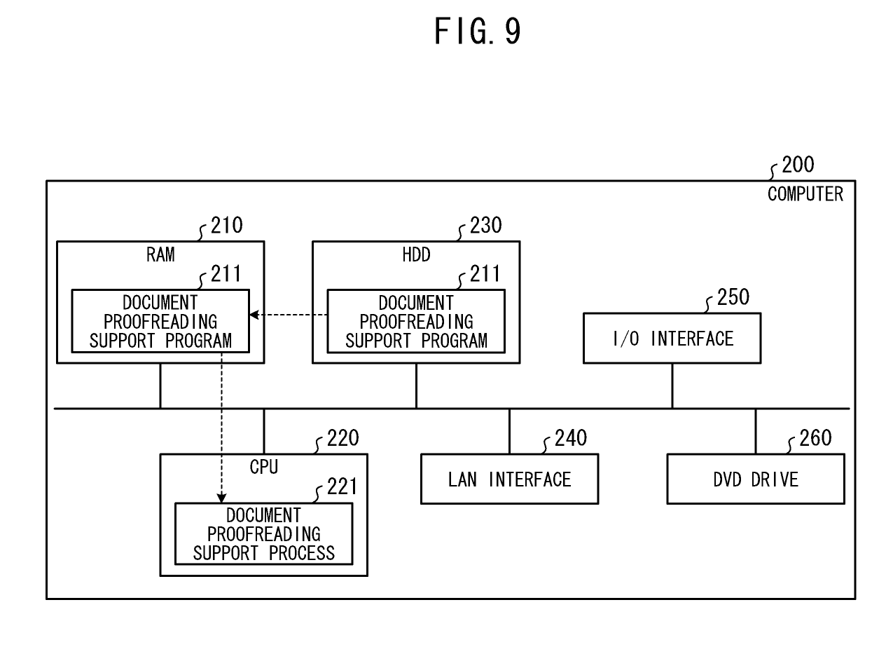

FIG. 9 is a functional block diagram illustrating a configuration of a computer for executing a document proofreading support program according to the present embodiment. As shown in this diagram, this computer 200 includes a RAM (Random Access Memory) 210, a CPU (Central Processing Unit) 220, an HDD (Hard Disk Drive) 230, a LAN (Local Area Network) interface 240, an I/O interface 250, and a DVD (Digital Versatile Disk) drive 260.

The RAM 210 is a memory for storing, for example, a program and/or an intermediate result of an execution of the program, and the CPU 220 is a central processing unit for reading the program from the RAM 210 to execute the program.

The HDD 230 is a disk device for storing a program and/or data, and the LAN interface 240 is an interface for connecting the computer 200 to another computer via a LAN.

The I/O interface 250 is an interface for connecting input devices such as a mouse and a keyboard, and a display device, and the DVD drive 260 is a device for reading from and writing to a DVD.

Furthermore, a document proofreading support program 211 executed by the computer 200 is stored on a computer-readable recording medium such as a DVD, read from the recording medium by the DVD drive 260, for example, and installed on the computer 200. Media used as the computer-readable recording medium may include, in addition to the above-mentioned DVD, a magnetic recording device, an optical disk, a magneto-optical recording medium, and a semiconductor memory.

Alternatively, the document proofreading support program 211 may be stored, for example, in a database of another computer system connected via the LAN interface 240, read from the database, and then installed on the computer 200.

Then, the installed document proofreading support program 211 may be stored in the HDD 230, read into the RAM 210, and then executed, as a document proofreading support process 221, by the CPU 220.

Furthermore, among the respective process steps described in the present embodiment, all of or part of the process steps, which have been described as being performed automatically, may be performed manually, or all of or part of the process steps, which have been described as being performed manually, may be performed automatically using a known method.

Furthermore, the process procedure, control procedure, specific names, various data, and information including parameters shown in the present document and drawings may be arbitrarily changed except when specified otherwise.

Moreover, respective constituting elements of each device shown in the drawings are provided based on functional concepts, and they do not necessarily have to be physically configured as shown in the drawings. In other words, a specific embodiment of distribution/integration of each device is not limited to those shown in the drawings, and each device may be entirely or partially configured by functional or physical distribution/integration in any unit in accordance with various loads, use situations, and the like.

Besides, all of or any part of each process function, performed in each device, may be implemented by a CPU and a program analyzed and executed by the CPU, or may be implemented as hardware using wired logic.

What is claimed is:

1. A computer-readable recording medium that records a document proofreading support program for supporting proofreading in which a term in a document created for each of a plurality of fields is replaced, wherein the document proofreading support program allows a computer to function as:
expression selection unit which selects, from a proofreading dictionary that stores a replacement source expression and a replacement destination expression in association with each other for each field, a replacement source expression associated with respective replacement destination expressions for a plurality of fields, and the respective replacement destination expressions for a plurality of fields associated with the replacement source expression;
list creation unit which extracts, for each of the replacement destination expressions for a plurality of fields selected by the expression selection unit, the replacement source expression associated with the replacement destination expression which is the same expression as the selected replacement destination expression from the proofreading dictionary, and creates an expression list including the extracted replacement source expression and the replacement destination expression associated with the extracted replacement source expression;
similarity determination unit which determines, among the expression lists for a plurality of fields created by the list creation unit, whether or not an expression group included in the expression list for one field is similar to an expression group included in the expression list for another field;
complementary dictionary generation unit which generates, when there exists the expression list for the another field determined as being similar by the similarity determination unit, a proofreading complementary dictionary for the one field, which associates an expression included in the expression list for the another field with a high replacement destination expression included in the expression list for the one field; and
proofreading support unit which supports proofreading of a document that is an object to be proofread by using the proofreading complementary dictionary generated by the complementary dictionary generation unit and the proofreading dictionary.

2. The computer-readable recording medium that records the document proofreading support program according to claim 1,
wherein after having created the expression list, the list creation unit extracts, from the proofreading dictionary, a replacement source expression associated with a replacement destination expression which is the same or similar expression as a replacement source expression included in the created expression list, and recursively repeats a process of adding the extracted replacement source expression to the expression list.

3. The computer-readable recording medium that records the document proofreading support program according to claim 2,
wherein after having created the proofreading complementary dictionary for the one field, if there exists an overlapping replacement source expression among the replacement source expressions included in the proofreading complementary dictionary and the replacement source expressions included in the proofreading dictionary, the complementary dictionary generation unit registers the overlapping replacement source expression in a replacement invalidation table, and
wherein as for proofreading in which a term of the replacement source expression registered in the replacement invalidation table is replaced, the proofreading support unit supports the proofreading of the document that is an object to be proofread by using the proofreading complementary dictionary.

4. A computer-aided document proofreading support method for supporting proofreading in which a term in a document created for each of a plurality of fields is replaced,
wherein the method allows a computer to perform
selecting, from a proofreading dictionary that stores a replacement source expression and a replacement destination expression in association with each other for each field, a replacement source expression associated with respective replacement destination expressions for a plurality of fields, and the respective replacement destination expressions for a plurality of fields associated with the replacement source expression;
extracting, from the proofreading dictionary, for each of the selected replacement destination expressions for a plurality of fields, the replacement source expression associated with the replacement destination expression which is the same expression as the selected replacement destination expression, and creating an expression list including the extracted replacement source expression, and the replacement destination expression associated with the replacement source expression;
determining, among the created expression lists for a plurality of fields, whether or not an expression group included in the expression list for one field is similar to an expression group included in the expression list for another field;
generating, when there exists the expression list for the another field determined as being similar by the determination, a proofreading complementary dictionary for the one field, which associates an expression included in the expression list for the another field with the high replacement destination expression included in the expression list for the one field; and
supporting proofreading of a document that is an object to be proofread by using the generated proofreading complementary dictionary and the proofreading dictionary.

5. The document proofreading support method according to claim 4,
wherein after the expression list has been created, a replacement source expression, associated with a replacement destination expression which is the same expression as a replacement source expression included in the created expression list, is extracted from the proofreading dictionary, and a process of adding the extracted replacement source expression to the expression list is recursively repeated.

6. The document proofreading support method according to claim 5,
wherein after the proofreading complementary dictionary for the one field has been created, if there exists an overlapping replacement source expression among the replacement source expressions included in the proofreading complementary dictionary and the replacement source expressions included in the proofreading dictionary, the replacement source expression is registered in a replacement invalidation table, and
wherein as for proofreading in which a term of the replacement source expression registered in the replacement invalidation table is replaced, the proofreading of the document that is an object to be proofread is supported by using the proofreading complementary dictionary.

7. A document proofreading support apparatus for supporting proofreading in which a term in a document created for each of a plurality of fields is replaced, wherein the document proofreading support apparatus comprises:
expression selection unit which selects, from a proofreading dictionary that stores a replacement source expression and a replacement destination expression in association with each other for each field, a replacement source expression associated with respective replacement destination expressions for a plurality of fields, and the respective replacement destination expressions for a plurality of fields associated with the replacement source expression;
list creation unit which extracts, for each of the replacement destination expressions for a plurality of fields selected by the expression selection unit, the replacement source expression associated with the replacement destination expression which is the same expression as the selected replacement destination expression from the proofreading dictionary, and creating an expression list including the extracted replacement source expression and the replacement destination expression associated with the extracted replacement source expression;
similarity determination unit which determines, among the expression lists for a plurality of fields created by the list creation unit, whether or not an expression group included in the expression list for one field is similar to an expression group included in the expression list for the another field;
complementary dictionary generation unit which generates, when there exists the expression list for the another field determined as being similar by the similarity determination unit, a proofreading complementary dictionary for the one field, which associates an expression included in the expression list for the another field with a high replacement destination expression included in the expression list for the one field; and
proofreading support unit which supports proofreading of a document that is an object to be proofread by using the proofreading complementary dictionary generated by the complementary dictionary generation unit and the proofreading dictionary.

8. The document proofreading support apparatus according to claim 7,
wherein after having created the expression list, the list creation unit extracts, from the proofreading dictionary, a replacement source expression associated with a replacement destination expression which is the same expression as a replacement source expression included in the created expression list, and recursively repeats a process of adding the extracted replacement source expression to the expression list.

9. The document proofreading support apparatus according to claim 8,
wherein after having created the proofreading complementary dictionary for the one field, if there exists an overlapping replacement source expression among the replacement source expressions included in the proofreading complementary dictionary and the replacement source expressions included in the proofreading dictionary, the complementary dictionary generation unit registers the replacement source expression in a replacement invalidation table, and
wherein as for proofreading in which a term of the replacement source expression registered in the replacement invalidation table is replaced, the proofreading support unit supports the proofreading of the document that is an object to be proofread by using the proofreading complementary dictionary.
